(19) United States
(12) Patent Application Publication
(10) Pub. No.: US 2004/0120669 A1
(43) Pub. Date: Jun. 24, 2004

(54) Allocation of optical fibers for parameter managed cables and cable systems

(76) Inventors: Brian F. Gallagher, Pfafftown, NC (US); Michael R. Raymond, Saskatoon (CA); Donald M. Witzel, Saskatoon (CA); Michael S. Fedoroff, Saskatoon (CA); William S. Jackman, Hickory, NC (US); Fern E. Young, Saskatoon (CA); Holly Knuttila, Saskatoon (CA)

Correspondence Address: CORNING CABLE SYSTEMS LLC, P O BOX 489, HICKORY, NC, 28603, US

(21) Appl. No.: 10/328,507

(22) Filed: Dec. 24, 2002

(51) Int. Cl. G02B 6/00

(52) U.S. Cl. 385/123

(57) ABSTRACT

An optical path for voice, video, and data transmission, and methods for manufacturing optical cables for use in optical transmission systems. The optical path or sub-paths have linearly and or non-linearly length dependant parameters which may have mutual relationships, for which local selection criteria allows a minimally restrictive local selection.

The present invention relates to the field of fiber optic cables, and, more particularly, to fiber optic cables having optical fibers with optical characteristics managed for reliable signal transmission performance in high data rate optical transmission systems.

### GENERAL BACKGROUND OF THE INVENTIONS

Fiber optic cables and systems are used to transmit telephone, television, and computer data information in indoor and outdoor environments. Optical performance can be affected by length dependent parameters, for example, optical attenuation, polarization mode dispersion, chromatic dispersion, and/or modal dispersion. Attenuation is a measure of loss of optical power over a system or length of fiber that is typically measured in dB/km. Since optical fiber symmetry is not perfect, and forces acting on the fiber are not uniformly applied, polarization modes may experience conditions that affect their propagation, whereby the modes will travel at different speeds. This effect is known as polarization mode dispersion (PMD). PMD can cause problems in high performance transmission systems. U.S. Pat. No. 6,278,828, incorporated by reference herein, discloses a method of controlling PMD.

Chromatic dispersion can be viewed as the sum of material and waveguide dispersions. Changes in refractive index with wavelength give rise to material dispersion. In glass (silica) fibers, material dispersion increases with wavelength over a wavelength range of about 0.9 μm to 1.6 μm. Material dispersion can have a negative or a positive sign depending on the wavelength. Waveguide dispersion results from light traveling in both the core and cladding of an optical fiber. Waveguide dispersion is also a function of wavelength and refractive index. Wavelength and material dispersion affects are typically summed yielding an overall positive or negative chromatic dispersion characteristic in a given optical fiber. Finally, in multi-mode optical fiber applications, since each propagation mode has its own propagation velocity through a step-index optical fiber, pulses spread out as they travel along the fiber, in what is known as modal dispersion.

A length dependent characteristic can be considered in traditional analyses in connection with the design and manufacture of optical transmission systems. A first traditional method involves identifying the maximum system specification value for a parameter (Psys−max), dividing it by the system length (Lsys), and setting the local cable piece maximum specification equal to this value, thereby defining a normalized specification value. Fibers are then selected randomly as long as they meet this normalized value. For short systems and relatively low performance system requirements, this method can be a sufficient and economically efficient approach. Maximum system lengths are quickly reached with this method. If, for example, an arbitrary length dependant parameter needs to have its absolute value less than 10 units at the system end. If this parameter has a mean value of 0.01 units per kilometer with a standard deviation of 0.5 units per kilometer, Throwing away approximately 5% of the product (95% yield) would allow a maximum span of 100 km.

For parameter managed systems such as the dispersion managed system described in Pat. No. 5,778,128, this method can be modified to have a target value and an acceptable range (Psys+Tar±Psys+range, Psys−Tar±Psys−range) for each fiber type with distinct different parametric values.

A problem exists, however, for longer systems with tighter or narrower Psys−max or Psys±range values. The normalized specification value can become so restrictive that manufacturing cables acceptable for the system becomes increasingly more difficult. A traditional statistical method can be used. For example, the parameter of interest is studied when the fibers are manufactured or cabled. The statistical method can include generating a parameter mean value (Pmean) and standard deviation for that parameter. Next, the number of independent optical fibers that will be concatenated in the system is estimated, and a standard deviation of the concatenated system is estimated. Using the same parameter and system example as before with a system max of 10 units and a normalized 0.01 units per kilometer with a standard deviation of 0.05 units per kilometer, the maximum system length would be approximately 360 km with a three sigma confidence for 5 km cable lengths while using all of the fibers. Depending on the allowable risk factor, the statistical method can employ two to six standard deviations that are subtracted from the Psys−max value to generate the parameter system goal (Psys−goal). The Psys−goal is then compared against the Pmean value. If the Psys−goal value is greater than Pmean, the system is manufactured using merely a random selection of fibers with an acceptable probability of meeting the system requirements. In the example

10−(3*.05*5)*square root (360/5)=3.636

(system requirement—3 sigma)

360*0.01=3.6

(Expected value)

Since 3.636 is greater than 3.6 the system would be satisfactory.

A similar statistical method can be used for parameter managed systems for each parametric requirement.

The foregoing statistical method can be difficult to manage, however. The optical characteristics and statistical values thereof are constantly changing due to, for example, optical fiber supply/inventory cycles. To illustrate, an inventory of optical fibers is wholly or partly consumed in the manufacture of optical cables. The next and succeeding inventories of optical fibers present constantly changing sets of optical performance characteristics and associated statistical values. The mean and standard deviation of a delivered fiber batch will typically rarely exactly match what is used in the pre-determined system selection calculations.

The maximum system length that can be reached using either of the foregoing methods is limited. For the example shown, 100 km or 360 km. In view of operational management, manufacturing, and cost constraints, very conservative estimations of the means and standard deviations are typically used. In addition, the foregoing methods do not take into account the use of optical transmission system components, for example, optical amplifiers and dispersion compensators. Additionally, the traditional methods are essentially static, and cannot dynamically account for installed cable lengths as the cable build progresses, nor can it account for multiple linear dependent parameters. Using the method of this invention, the maximum span for the example parameter a single span of 1000 km could be reached with no fiber yield impact and a hundred percent confidence. For system length distributions, much longer systems could be achieved with 100 percent confidence with no yield effect.

Maximum system reach may be partially based on balancing pairs of fibers according to length dependent parameters, for example, chromatic dispersion. Chromatic dispersion affects of a fiber optic cable system design are described in U.S. Pat. No. 5,611,016. The patent pertains to a dispersion-balanced optical cable for reducing four-photon mixing in Wave Division Multiplexing systems, the cable being designed to reduce cumulative dispersion to near zero over the system length. The dispersion-balanced optical cable requires positive and negative dispersion fibers in the same cable. Further, the positive dispersion aspect includes dispersion characteristic selection criteria defined as the average of the absolute magnitudes of the dispersions of the positive dispersion fibers exceeding 0.8 ps/nm.km at a source wavelength. In addition, the negative dispersion fiber characteristic selection criteria requires the average of the absolute magnitudes of the dispersions of the negative dispersion to exceed 0.8 ps/nm.km at the source wavelength. The aforementioned optical fibers are single-mode fibers designed for the transmission of optical signals in the 1550 nm wavelength region. At defined parameters, the positive-dispersion characteristic is ±2.3 ps/nm.km and the negative-dispersion characteristic is −1.6 ps/nm.km.

Other optical fiber selection concepts are incorporated in the background of the present invention. For example, optical attenuation fiber selection is discussed in U.S. Pat. No. 5,608,832, wherein construction of an optical component, for example, an optical fiber ribbon is disclosed. Optical fibers in the optical ribbon are selected based on measured mechanical sensitivities resulting in optical attenuation deltas. In other words, optical fibers are placed in specific positions in the optical ribbon based on their response to mechanical stressing. The waveguides having a low mechanical sensitivity are disposed in those regions of the optical ribbon which are likely to experience elevated mechanical stressing, for example, in edge fiber locations.

Multi-mode optical fibers can be selected based on modal dispersion characteristics, as discussed in U.S. Pat. No. 4,205,900. Over-compensated and under-compensated fibers, or cable sections, are alternately connected so that each fiber or cable section tends to correct the modal dispersion originating in the previous fiber or cable section. This arrangement is designed to substantially reduce the variation of bandwidth with source wavelength.

### Aspects of the Inventions

In one exemplary aspect, the present invention sets forth dynamic selection criteria for selecting fibers for cables to be installed in a proposed optical path for signal transmission with one or more end-to-end, sectional or span specific specified independent length dependent parameters by having a local fiber selection criteria based on end-to-end requirements, sectional requirements, span requirements, parametric values for previously selected fibers in the fiber string, and the probable available distribution of the parameters used for selection; selecting a fiber, checking if the fiber meets the local selection criteria and generating a new local selection criteria. If the new local selection criteria is satisfactory and the fiber meets the old selection criteria, allocating it; and moving on to a different fiber increment in the system for selection, otherwise putting the fiber back into inventory and selecting a different fiber.

In another exemplary aspect of the present invention at least two of the parameters being controlled have an inter-dependent relationship. The current local and new local selection criteria reflect this relationship. Other aspects are disclosed in the following detailed description of the inventions.

### BRIEF DESCRIPTION OF THE DRAWING FIGURES

FIG. 1 is a schematic view of an exemplary fiber optic cable system, and associated span groups, spans, and span sections, according to the present inventions.

FIG. 2 is a schematic system diagram of the fiber optic cable system of FIG. 1.

FIG. 3 is an exemplary flow chart illustrating a process for selecting optical fibers for a parameter managed optical transmission system according to the present inventions.

FIG. 4 is an exemplary flow chart illustrating a process for selecting optical fibers with essentially linearly dependent parameters according to the present inventions.

FIG. 5 is a schematic view of a fiber characteristic distribution curve.

### DETAILED DESCRIPTION OF THE INVENTION

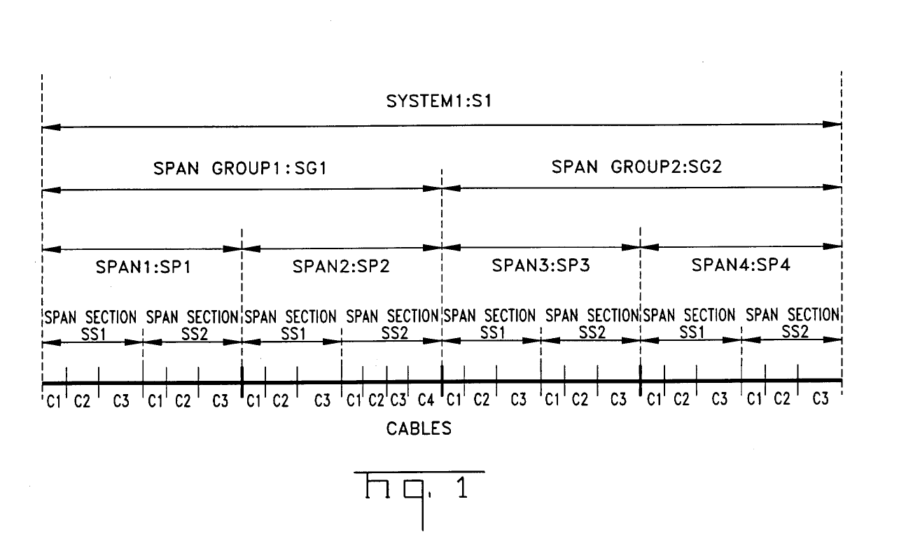

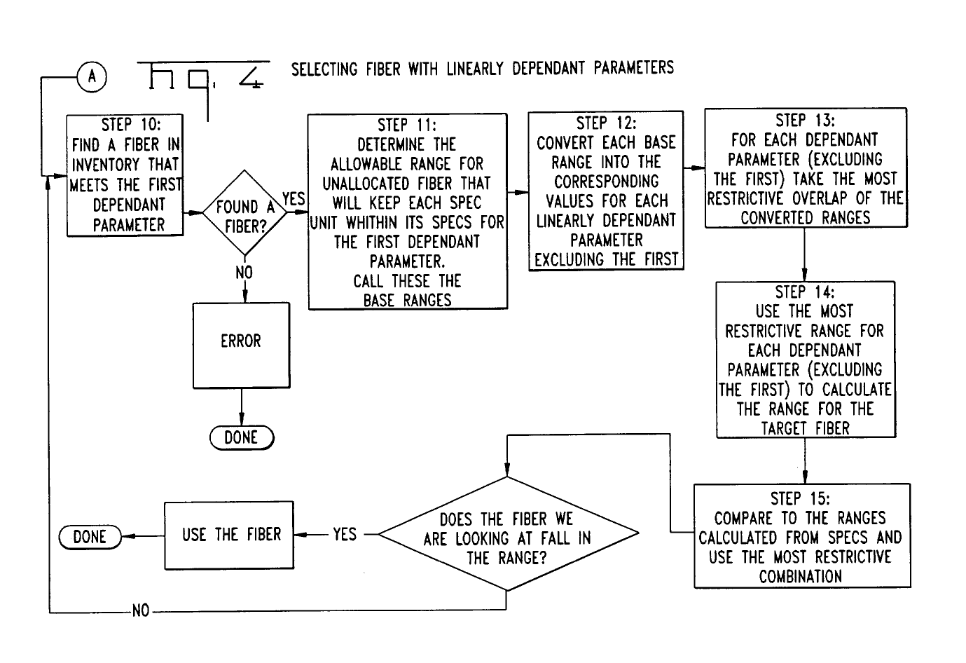

Referring to FIGS. 1-4, fiber optic cables and systems, and methods for selecting optical components for such cables and systems, in the context of a dispersion managed cable system (DMCS), according to embodiments of the present invention, will be described. Fiber optic cables according to the present inventions can include a single optical fiber type or they can define a hybrid design containing at least two different optical fiber types. Generally, the cables of the present inventions include silica-based optical fibers, for example, that are made available by Corning Incorporated. The optical fibers can be colored with, for example, UV curable inks.

Exemplary DMCS optical fibers used in the present invention are single mode fibers having predetermined length dependent optical performance characteristics, for example, chromatic dispersion at multiple source wavelengths and optical attenuation characteristics. The performance characteristics can be evaluated at multiple wavelength regions. In general, the range of absolute values of the chromatic dispersion can be between about 16 to about 36 ps/nm.km at 1550 nm. For example, the positive dispersion optical fibers have a dispersion of about 16 to 22 ps/nm.km at 1550 nm, and the negative dispersion optical fibers have a dispersion of about negative 24 to about negative 33 ps/nm.km at 1550 nm. For hybrid parameter spans, such as the exemplary dispersion managed spans, the cable can include both positive and negative dispersion fibers, or a single type of dispersion managed fiber to be selected using the present inventions. Systems including the present inventions can include non-DMCS fibers which may be selected using the methods of the present inventions, for example, LEAF®, SMF-28 optical fibers, or METROCOR™ fibers made available by Corning Incorporated. For other parametric managed systems any random fiber type or types may be those selected using methods of the present inventions.

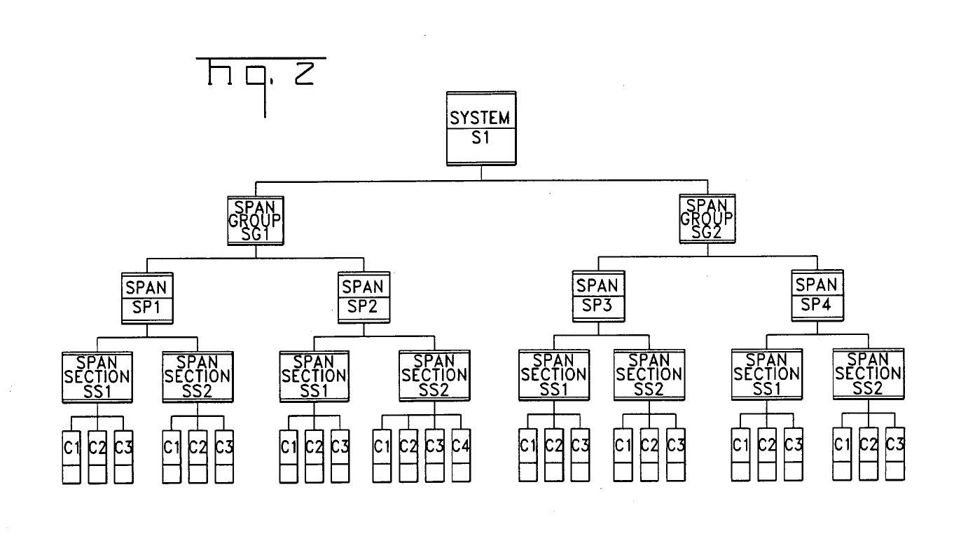

Referring to FIGS. 1 and 2, the present inventions will be described with reference to an exemplary optical transmission system S1. S1 comprises at least one span group, two span groups SG1 and SG2 are shown in FIGS. 1-2. Likewise, the span groups can comprise respective spans which can comprise span sections. Each span section comprises at least one fiber optic cable, containing one or more optical fiber pieces. All cables in a span section are preferably of the same type depending on the system requirements. Each span section in the exemplary embodiment comprises up to four cables C1,C2,C3,C4 having optically concatenated positive or negative dispersion fibers. For example, the first span section C1,C2,C3 comprises positive dispersion fibers (P) optically interconnected with a negative dispersion span section C1,C2,C3 (N), and so on, across the system. In the present example, it is preferred without limitation that each and every sub-component of the system is being evaluated for its respective length dependent parameters, for example, positive or negative dispersion at two wavelengths and attenuation. Systems according to the present invention can include fibers in each cable that are carrying information in opposite directions.

The optical fiber selection process according to the present invention acknowledges ranges of optical performance parameters based on a given transmission system specification. Other parameters can be based on the characteristics of the fiber already selected along the fiber path, e.g., the allocated optical fibers; and/or characteristics of optical fibers that could be selected, as from inventory, anticipated delivery or special order, for installation in the piece being, or to be, manufactured.

In accomplishing the foregoing, the present inventions provide fiber selection methods for, in a first aspect, a parameter managed system. A parameter managed system is a concatenation of optical fibers having performance characteristics, the characteristics of which must meet one or more performance targets. Targets are defined by performance parameters. Different targets for the same or different parameters can be established for individual system, section and/or span requirements. The targets can be nominals with a range, maximums, or minimums as needed. The targets can be changed during the manufacturing of the system, often with no yield effect. These targets can occur on arbitrary groupings of fibers, for example, optical fibers in an inventory of a cable or optical fiber factory. The fibers in any grouping must be in a continuous or essentially continuous series or optical path. In the present example, there are twenty-five concatenated cables or pieces. As noted above, they are stratified for illustration in a span section, span, span group, and system architecture. Each, or any of these, as an individual fiber string can be a unit with a target.

For a unit in the system and in an arbitrary grouping of the architecture, for a length dependant parameter, to determine the acceptable range dₚ that a particular fiber must fall into, it can be shown that:

$$T - {V}_{L} \leq {d}_{p} {l}_{p} + {‖}_{Lower}^{Upper} \sum {d}_{u} {l}_{u} + \sum {d}_{A} {l}_{A} \leq T + {V}_{U} \qquad ( 1 )$$

where:

T=the target value for that parameter in that unit;

V_{L}=the-allowed lower variation around the target;

V_{U}=the allowed upper variation around the target;

dₚ=the value of the particular piece being selected for;

lₚ=the length of the particular piece being selected for;

dᵤ=the possible values for pieces not yet selected in that unit;

lᵤ=the length of pieces not yet selected in that unit;

d_{A}=the value of the pieces already selected (allocated); and

l_{A}=the length of pieces already selected.

In accordance with the present inventions, since it is desired to determine the acceptable values of the piece being selected, as from the inventory of optical fibers, the equations are rearranged providing a range of acceptable values:

$$( T - {V}_{L} - {‖}^{Upper} \sum {d}_{u} {l}_{u} - \sum {d}_{A} {l}_{A} ) / {l}_{p} \leq {d}_{p} \geq {( T + {V}_{u} - ‖}_{Lower} \sum {d}_{u} {l}_{u} - \sum {d}_{A} {l}_{A} ) / {l}_{p} \qquad ( 2 )$$

Pieces that have not been selected can have a range of possible optical performance values. This range must be such that it is reasonable to expect to find these values in, e.g., the fiber inventory, when it comes time to select these pieces. The maximum and minimum reasonable values are termed:

d_{u max}

and

d_{u min}

The range of acceptable values becomes:

$$\begin{matrix}( T - {V}_{L} - \sum {d}_{u max} {l}_{u} - \sum {d}_{A} {l}_{A} ) / {l}_{p} \leq {d}_{p} \leq ( T + {V}_{U} - \sum {d}_{u min} {l}_{u} - \sum {d}_{A} {l}_{A} ) {l}_{p} \\ so & ( 3 ) \\ {d}_{p min} = ( T - {V}_{L} - \sum {d}_{u max} {l}_{u} - \sum {d}_{A} {l}_{A} ) / {l}_{p} \\ and & ( 4 a ) \\ {d}_{p max} = ( T + {V}_{U} - \sum {d}_{u min} {l}_{u} - \sum {d}_{A} {l}_{A} ) / {l}_{p} & ( 4 b )\end{matrix}$$

The calculation of dᵤₘₐₓ and dᵤₘᵢₙ can be complicated and is based on statistics and optical fiber inventory issues, explained more fully herein below. There are separate sets of values for each different fiber type in the system. In the present example of concatenated fibers, there are two types of fiber, positive and negative dispersion fibers; however, other types of fibers can be in any given cable, and not be a part of the instant optical fiber path. The result is that:

dᵤₘₐₓ=dₘₑₐₙ+rs_{d} (5a)

and

dₘᵢₙ=dₘₑₐₙ−rs_{d} (5b)

where: dₘₑₐₙ is the mean value of the parameter for a particular type of fiber; s_{d} is the standard deviation; and r is a risk factor that is determined from a statistical analysis For example, r could be the concatenated system three sigma expected variation and calculated using

r=3\sqrt{Nᵤ} (6)

Where;

Nᵤ is the number of unallocated fiber sections in the unit.

r can also be a constant or mapping function that has been found empirically to meet the needs of the system. Most fiber parametric distributions are not truly Gaussian, and typically are not populated enough that a selected subset will normally converge to an expected value with a sigma with a distribution whose risk can be defined using equation 6.

Calculation of possible values of unallocated fibers according to the present inventions will now be described. For linearly dependent parameters the equations for calculating acceptable fiber ranges are:

$${d}_{p min} = ( T - {V}_{L} - \sum {d}_{u max} {l}_{u} - \sum {d}_{A} {l}_{A} ) / {l}_{p} \\ and \\ {d}_{p max} = ( T - {V}_{U} - \sum {d}_{u min} {l}_{u} - \sum {d}_{A} {l}_{A} ) / {l}_{p} \qquad ( 7 )$$

The only unknowns on the right side are dᵤₘₐₓ and dᵤₘᵢₙ. These are the most extreme reasonable values that could be used for the unallocated values. Reasonable means that one could expect to find enough of this unallocated fiber to build the contemplated unit, and the average value of these unallocated fibers would be dᵤₘₐₓ and dᵤₘᵢₙ. These values are determined as follows.

The total unallocated length is

$${L}_{u} = \sum {l}_{u}^{P} + \sum {l}_{u}^{N} = {L}_{u}^{P} + {L}_{u}^{N} . \qquad ( 8 )$$

where the superscripts indicate positive or negative fiber.

The total fiber currently in inventory is:

L_{I}^{P}=positive_inventory

and

L_{I}^{N}=negative_inventory

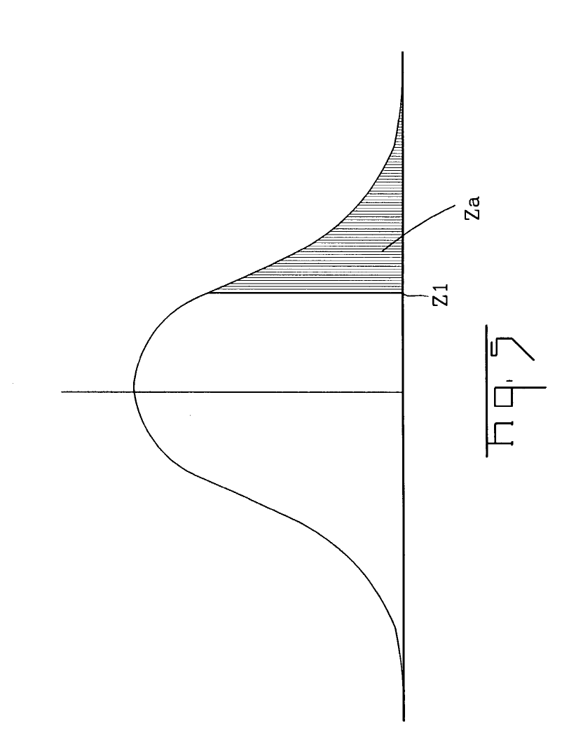

Unallocated fiber with high values (dᵤₘₐₓ) would come from the right side of the normally distributed fiber as indicated by the shaded portion of FIG. 5.

Unallocated fiber with low values (dᵤₘᵢₙ) would come from the left side (the mirror image of the shaded portion). Z₁ is the multiplier for a singular standard deviation which would define a cumulative product of:

$$\frac{LI - LU}{LI} . \qquad ( 9 )$$

The probability of finding this fiber is:

$$p = {\int }_{{z}_{1}}^{∞} f ( z ) ⅆ z . \qquad ( 10 )$$

So the amount of fiber one can expect to find is the probability multiplied by the amount in inventory. There could be issues with fiber lengths and waste, which could result in the actual probability being less, but these affects are not included in this step. Each type of fiber has its own distribution so

$${L}_{u}^{P} = {L}_{I}^{P} {\int }_{{z}_{1}^{P}}^{∞} f ( z ) ⅆ z \\ and \\ {L}_{u}^{N} = {L}_{I}^{N} {\int }_{{z}_{1}^{N}}^{∞} f ( z ) ⅆ z . \qquad ( 11 )$$

It is then desirable to actually know how much fiber is needed for the unallocated pieces, so the only unknowns are z₁^{P} and Z₁^{N} Rearranging gives:

$$\frac{{L}_{u}^{P}}{{L}_{I}^{P}} = {\int }_{{z}_{1}^{P}}^{∞} f ( z ) ⅆ z \\ and \\ \frac{{L}_{u}^{N}}{{L}_{I}^{N}} = {\int }_{{z}_{1}^{N}}^{∞} f ( z ) ⅆ z . \qquad ( 12 )$$

The next step is to solve for z₁^{P} and Z₁^{N}. This can be done using standard tables for normal distributions.

The next step is to find the average value for the shaded region. It is then desirable to call this average value Z_{A}. If dₘₑₐₙ is the mean and S_{d} is the standard deviation then the total value of the parameter multiplied by length can be expressed two ways:

$${\int }_{{z}_{1}}^{∞} ( {d}_{mean} + {zs}_{d} ) {L}_{I} f ( z ) ⅆ z = {\int }_{{z}_{1}}^{∞} ( {d}_{mean} + {z}_{A} {s}_{d} ) {L}_{I} f ( z ) ⅆ z \\ or \\ {d}_{mean} {L}_{I} {\int }_{{z}_{1}}^{∞} f ( z ) ⅆ z + {s}_{d} {L}_{I} {\int }_{{z}_{1}}^{∞} zf ( z ) ⅆ z = {d}_{mean} {L}_{I} {\int }_{{z}_{1}}^{∞} f ( z ) ⅆ z + {z}_{A} {s}_{d} {L}_{I} {\int }_{{z}_{1}}^{∞} f ( z ) ⅆ z \qquad ( 13 )$$

then canceling like terms gives:

$${\int }_{{z}_{1}}^{∞} zf ( z ) ⅆ z = {z}_{A} {\int }_{{z}_{1}}^{∞} f ( z ) ⅆ z . \qquad ( 14 )$$

This simplifies to:

$${z}_{A} = \frac{{\int }_{{z}_{1}}^{∞} zf ( z ) ⅆ z}{{\int }_{{z}_{1}}^{∞} f ( z ) ⅆ z} \qquad ( 15 )$$

This can be solved by numerical integration yielding:

Z_{A}=0.0132z₁⁵+0.0187z₁⁴−0.086z₁³+0.0153z₁²+0.6815z₁+0.8336 (16) which is valid for:

−2.5≦z₁≦2.5.

Then the most extreme values to be found are:

$$\begin{matrix}\sum {d}_{u max} {l}_{u} = {U}_{max}^{expected} \\ = ( {d}_{mean}^{P} + {z}_{A}^{P} {s}_{d}^{P} ) \sum {l}_{u}^{P} + ( {d}_{mean}^{N} + {z}_{A}^{N} {s}_{d}^{N} ) \sum {l}_{u}^{N}\end{matrix} \\ and \\ \begin{matrix}\sum {d}_{u min} {l}_{u} = {U}_{min}^{expected} \\ = ( {d}_{mean}^{P} - {z}_{A}^{P} {s}_{d}^{P} ) \sum {l}_{u}^{P} + ( {d}_{mean}^{N} - {z}_{A}^{N} {s}_{d}^{N} ) \sum {l}_{u}^{N}\end{matrix} \qquad ( 17 )$$

From the equations it can be seen that as the ratio of inventory L_{I} to amount required for unallocated Lᵤ goes up then fiber having more extreme characteristics can be used.

Simulations by-the present inventors using a value of 1.3 for Z_{A} (both positive and negative) have worked well.

If it is desired to control multiple parameters simultaneously, then the result is a set of equations which give a set of ranges for each parameter. Optical performance parameters can be independent or related to each other, for example, with respect to source wavelength. An example of this is the chromatic dispersion characteristic parameter. To illustrate, optical fibers having a high chromatic dispersion at one source wavelength will very likely have a high chromatic dispersion at a different source wavelengths. The relationship for chromatic dispersions is accepted to be essentially linear:

d_{wavelength2}=M₁₂d_{wavelength1}+B₁₂ (18)

where M₁₂ and B₁₂ are constants derived from empirical and/or theoretical mapping of the dispersion wavelength response. For parameters with a known linear response, such as dispersion, a linear regression analysis is often used. An assumption of ideal linearity must be balanced with the understanding derived empirically that the actual chromatic dispersion values, or other parameters with effectively linear relationships, for optical fibers are variable around or about these ideal lines, in a normal fashion, with standard deviations of S_{d12} and S_{d2}. This variability is incorporated in the definition of essentially linearly related parameters used herein. The two essentially linearly related parameters dₚ₁ and dₚ₂ must be controlled, then equations 5 are solved first to get the ranges of each parameter independently:

$${d}_{p min 1} = ( {T}_{1} - {V}_{1} - {U}_{max 1}^{expected} - \sum {d}_{A1} {l}_{A} ) / {l}_{p} \\ {d}_{p max 1} = ( {T}_{1} + {V}_{1} - {U}_{min 1}^{expected} - \sum {d}_{A1} {l}_{A} ) / {l}_{p} \\ and \\ {d}_{p min 2} = ( {T}_{2} - {V}_{2} - {U}_{max 2}^{expected} - \sum {d}_{A2} {l}_{A} ) / {l}_{p} \\ {d}_{p max 2} = ( {T}_{2} + {V}_{2} - {U}_{min 2}^{expected} - \sum {d}_{A2} {l}_{A} ) / {l}_{p} \qquad ( 19 )$$

Then a fiber is selected that satisfies these ranges. Next, the selected value of dₚ₁ is used to recalculate the acceptable value range limits (Uₘᵢₙ₁ and Uₘₐₓ₁) for the remainder of the unallocated unit for parameter 1.

$${U}_{min 1}^{new} = {( \sum {d}_{u min 1} {l}_{u} )}_{new} = {T}_{1} - {V}_{1} - {d}_{p1} {l}_{p} - \sum {d}_{A1} {l}_{A} \\ and \\ {U}_{max 1}^{new} = {( \sum {d}_{u max 1} {l}_{u} )}_{new} = {T}_{1} + {V}_{1} - {d}_{p1} {l}_{p} - \sum {d}_{A1} {l}_{A} \qquad ( 20 )$$

The new values must fit within the original ranges:

U_{min 1}^{new}≧U_{min 1}^{exp ected}

and

U_{max 1}^{new}≦U_{max 1}^{exp ected} (21)

Next the U^{new}ₘᵢₙ₁ and U^{new}ₘₐₓ₁ are converted to the equivalent values for parameter 2. In the example there are two fiber types in the end-to-end system with different distribution parameters. Equation 22 shows the relationship used for the example with two fiber types. Equations for the relationship for three or more fiber types could be derived as needed. The superscripts refer to the type of fiber, i.e., positive or negative chromatic dispersion.

$${U}_{min 2}^{new} = ( {d}_{mean2}^{P} + {x}_{min} {z}_{A}^{P} {M}_{12}^{P} {s}_{d1}^{P} - {r}_{12}^{P} {s}_{d12}^{P} ) \sum {l}_{u}^{P} + ( {d}_{mean2}^{N} + {x}_{min} {z}_{A}^{N} {M}_{12}^{N} {s}_{d1}^{N} - {r}_{12}^{N} {s}_{d12}^{N} ) \sum {l}_{u}^{N} \\ and \\ {U}_{max 2}^{new} = ( {d}_{mean2}^{P} + {x}_{max} {z}_{A}^{P} {M}_{12}^{P} {s}_{d1}^{P} + {r}_{12}^{P} {s}_{d12}^{P} ) \sum {l}_{u}^{P} + ( {d}_{mean2}^{N} + {x}_{max} {z}_{A}^{N} {M}_{12}^{N} {s}_{d1}^{N} - {r}_{12}^{N} {s}_{d12}^{N} ) \sum {l}_{u}^{N} \\ where \\ {x}_{min} = ( {U}_{min 1}^{new} - {d}_{mean1}^{P} \sum {l}_{u}^{P} - {d}_{mean1}^{N} \sum {l}_{u}^{N} ) / ( {z}_{A}^{P} {s}_{d1}^{P} \sum {l}_{u}^{P} + {z}_{A}^{N} {s}_{d1}^{N} \sum {l}_{n}^{N} ) \\ and \\ {x}_{max} = ( {U}_{max 1}^{new} - {d}_{mean1}^{P} \sum {l}_{u}^{P} - {d}_{mean1}^{N} \sum {l}_{u}^{N} ) / ( {z}_{A}^{P} {s}_{d1}^{P} \sum {l}_{u}^{P} + {z}_{A}^{N} {s}_{d1}^{N} \sum {l}_{n}^{N} ) \\ also \\ {x}_{min} \geq - 1 and {x}_{max} \leq 1 \qquad ( 22 )$$

where, as explained above: S_{d12} is the standard deviation around the ideal linear value. In addition, r₁₂ is a value determined statistically to yield a range values that are reasonably expected to be found around the ideal linear value. This variability is incorporated in the notion of essentially linearly related parameters. U^{new}ₘᵢₙ₂ and U^{new}ₘₐₓ₂ are then used to recalculate dₚₘᵢₙ₂ and dₚₘₐₓ₂:

$${d}_{p min 2}^{new} = ( {T}_{2} - {V}_{2} - {U}_{max 2}^{new} - \sum {d}_{A2} {l}_{A} ) / {l}_{p} \\ {d}_{p max 2}^{new} = ( {T}_{2} + {V}_{2} - {U}_{min 2}^{new} - \sum {d}_{A2} {l}_{A} ) / {l}_{p} \qquad ( 23 )$$

If the optical fiber selected from inventory which met all parameter requirements and meets the relational requirements, then the fiber can be used in the cable piece. If not, then the fiber selection tool is indexed to the next fiber in inventory. The process can be repeated until a fiber is found that meets the requirements. This process can be accomplished by a computer program based on a readily available programming language, package or software, for example: Microsoft® Excel97XCEL.

In summary, one aspect of the present invention is therefore a method for selecting an optical fiber for use in a optical path, the method having the steps of:

(a) determining at least two length dependent, essentially linearly related optical parameters associated with the optical path;

(b) identifying at least two optical fibers to be in optical communication along the optical transmission path, thereby defining first and second optical fibers;

(c) determining optical characteristics respectively of the first and second optical fibers that are complementary to that of the essentially linearly related optical parameters; and

(d) selecting the second optical fiber, for inclusion in the optical path, with reference to the optical characteristics of the first optical fiber so that the optical characteristics of the second optical fiber are within a predetermined optical performance range.

An example of the foregoing is as follows. Referring to FIGS. 1-2, it is desired to build a cable system by selecting a fiber from inventory or another source for C1, starting with the allocation of one fiber piece in cable C3 of span section SS1, in span SP1, span group SG1, of system S1. It will be identified as S1-SG1-SP1-SS1 (system/span group/span/span section/cable). For the purposes of the example assume the fiber in S1-SG1-SP1-SS1-C3 is already allocated and has the following characteristics: dispersion @1560 equal to 52 ps/nm.km, dispersion @1620 equal to 54 ps/nm.km, attenuation @1550 equal to 0.24 dB/km. Further assume fiber distributions for dispersion values: positive fibers @1560 nm and 1620 nm, mean equal to 50 ps/nm-km, standard deviation equal to 5; and negative fibers @1560 nm and 1620 nm, mean equal to −50 ps/nm-km, standard deviation equal to 5. Assume system specs: for SG1, dispersion equal to −20 to 20 ps/nm-km @1560 nm and 1620 nm; for SP1, dispersion equal to −30 to 30 ps/nm-km @1560 nm and 1620 nm; for Sp2, dispersion equal to −30 to 30 ps/nm-km @1560 nm and 1620 nm; and for S1, attenuation less than or equal to 0.30 dB/km for all fibers. In addition, assume fiber distributions for attention @1550, mean equal to 0.22 dB/km, with a standard deviation of 0.05.

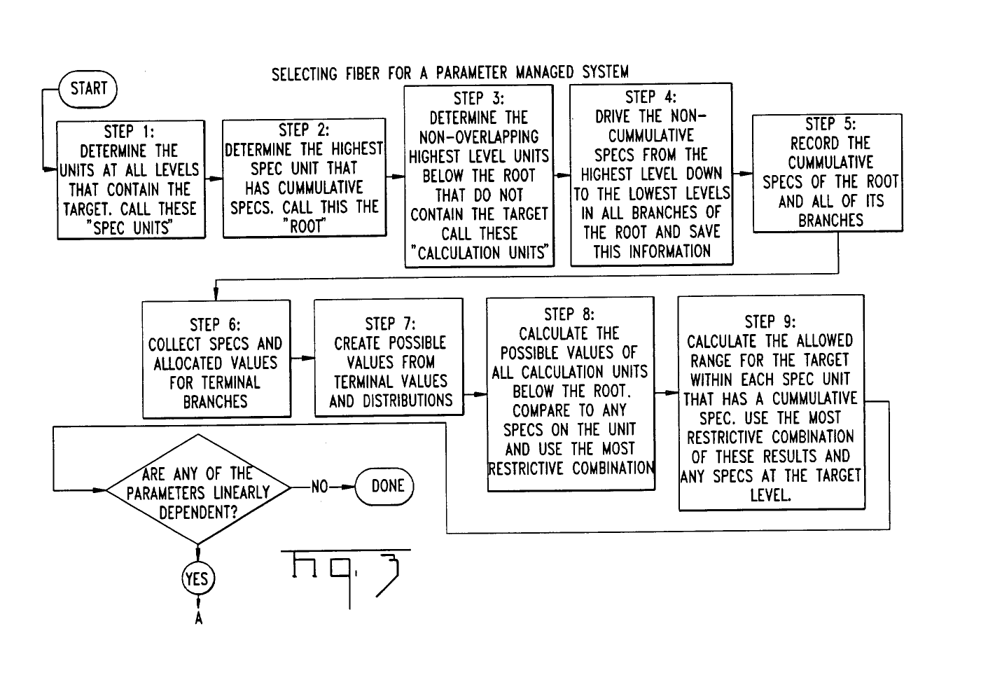

With reference to FIG. 3, selecting an optical fiber for a parameter managed system as shown in FIGS. 1-2, in accordance with the present invention, will be described.

Step 1: Determine the units at all levels that contain the target, called spec units.

### EXAMPLE

Target = S1-SG1-SS1-C1.

| Unit ID | Level |
|---|---|
| S1 | 1 |
| S1-SG1 | 2 |
| S1-SG1-SP1 | 3 |
| S1-SG1-SP1- | 4 |
| SS1 | |

Step 2: Determine the highest level spec unit that has cumulative specs. Call this the “root.”

### EXAMPLE

Root = S1-SG1

Step 3: Determine the non-overlapping highest level spec units, below the root, that don't contain the target. Call these “calculation units.”

### EXAMPLE

Calculation units.

| Unit ID | Level |
|---|---|
| S1-SG1-SP1- | 5 |
| SS1-C2 | |
| S1-SG1-SP1- | 5 |
| SS1-C3 | |
| S1-SG1-SP1- | 4 |
| SS2 | |
| S1-SG1-SP2 | 3 |

Step 4: Drive the non-cumulative specs from the highest level down to the lowest levels in all branches of the root and save this information. The attenuation is non-cumulative.

### EXAMPLE

| Terminal branch ID | Spec type | Min value | Max value |
|---|---|---|---|
| S1-SG1-SP1-SS1-C1 | Atten@1550 | 0 | 0.3 |
| S1-SG1-SP1-SS1-C2 | Atten@1550 | 0 | 0.3 |
| S1-SG1-SP1-SS1-C3 | Atten@1550 | 0 | 0.3 |
| S1-SG1-SP1-SS2-C1 | Atten@1550 | 0 | 0.3 |
| S1-SG1-SP1-SS2-C2 | Atten@1550 | 0 | 0.3 |
| S1-SG1-SP1-SS2-C3 | Atten@1550 | 0 | 0.3 |
| S1-SG1-SP2-SS1-C1 | Atten@1550 | 0 | 0.3 |
| S1-SG1-SP2-SS1-C2 | Atten@1550 | 0 | 0.3 |
| S1-SG1-SP2-SS1-C3 | Atten@1550 | 0 | 0.3 |
| S1-SG1-SP2-SS2-C1 | Atten@1550 | 0 | 0.3 |
| S1-SG1-SP2-SS2-C2 | Atten@1550 | 0 | 0.3 |
| S1-SG1-SP2-SS2-C3 | Atten@1550 | 0 | 0.3 |
| S1-SG1-SP2-SS2-C4 | Atten@1550 | 0 | 0.3 |

Step 5: Record the cumulative specs of the root and all of its branches.

### EXAMPLE

| Unit ID | Spec type | Min value | Max value |
|---|---|---|---|
| S1-SG1 | DISP@1560 | −20 | 20 |
| S1-SG1 | DISP@1620 | −20 | 20 |
| S1-SG1-SP1 | DISP@1560 | −30 | 30 |
| S1-SG1-SP1 | DISP@1620 | −30 | 30 |
| S1-SG1-SP2 | DISP@1560 | −30 | 30 |
| S1-SG1-SP2 | DISP@1620 | −30 | 30 |

Step 6: Collect specs and allocated values for terminal branches.

### EXAMPLE

| Terminal | Spec | Min | Max | | | Fiber |
|---|---|---|---|---|---|---|
| branch ID | type | value | value | Allocated | Length | type |
| S1-SG1-SP1- | ATTEN@ | 0 | 0.3 | No | 8 | Pos |
| SS1-C1 | 1550 | | | | | |
| S1-SG1-SP1- | ATTEN@ | 0 | 0.3 | No | 8 | Pos |
| SS1-C2 | 1550 | | | | | |
| S1-SG1-SP1- | ATTEN@ | 0.24 | 0.24 | Yes | 8 | Pos |
| SS1-C3 | 1550 | | | | | |
| S1-SG1-SP1- | DISP@1560 | 52 | 52 | Yes | 8 | Pos |
| SS1-C3 | | | | | | |
| S1-SG1-SP1- | DISP@1620 | 54 | 54 | Yes | 8 | Pos |
| SS1-C3 | | | | | | |
| S1-SG1-SP1- | ATTEN@ | 0 | 0.3 | No | 8 | Neg |
| SS2-C1 | 1550 | | | | | |
| S1-SG1-SP1- | ATTEN@ | 0 | 0.3 | No | 8 | Neg |
| SS2-C2 | 1550 | | | | | |
| S1-SG1-SP1- | ATTEN@ | 0 | 0.3 | No | 8 | Neg |
| SS2-C3 | 1550 | | | | | |
| S1-SG1-SP2- | ATTEN@ | 0 | 0.3 | No | 8 | Pos |
| SS1-C1 | 1550 | | | | | |
| S1-SG1-SP2- | ATTEN@ | 0 | 0.3 | No | 8 | Pos |
| SS1-C2 | 1550 | | | | | |
| S1-SG1-SP2- | ATTEN@ | 0 | 0.3 | No | 8 | Pos |
| SS1-C3 | 1550 | | | | | |
| S1-SG1-SP2- | ATTEN@ | 0 | 0.3 | No | 6 | Nege |
| SS2-C1 | 1550 | | | | | |
| S1-SG1-SP2- | ATTEN@ | 0 | 0.3 | No | 6 | Neg |
| SS2-C2 | 1550 | | | | | |
| S1-SG1-SP2- | ATTEN@ | 0 | 0.3 | No | 6 | Neg |
| SS2-C3 | 1550 | | | | | |
| S1-SG1-SP2- | ATTEN@ | 0 | 0.3 | No | 6 | Neg |
| SS2-C4 | 1550 | | | | | |

Step 7: Establish a data set with possible parametric contributions for each fiber that will affect the root, these values may be from the Distribution of expected values for that parameter, a specification for that parameter for sections not allocated, or from known values for fibers which have been allocated.

### EXAMPLE

| | | | | | | | | | | Min | Max | |
|---|---|---|---|---|---|---|---|---|---|---|---|---|
| | | Min | Max | | | | Min | Max | | system | system | |
| Terminal | | value | value | Min | Max | | value | value | | contribution | contribution | |
| branch | Spec | from | from | from | from | | per | per | Len | from | from | Fib |
| ID | type | distribution | distribution | spec | spec | Allocated | km | km | (km) | branch | branch | type |
| S1-SG1- | DISP@ | 43.5 | 56.5 | | | | 43.5 | 56.5 | 8 | 348 | 452 | Pos |
| SP1-SS1- | 1560 | | | | | | | | | | | |
| C1 | | | | | | | | | | | | |
| S1-SG1- | DISP@ | 43.5 | 56.5 | | | | 43.5 | 56.5 | 8 | 348 | 452 | Pos |
| SP1-SS1- | 1620 | | | | | | | | | | | |
| C1 | | | | | | | | | | | | |
| S1-SG1- | ATTEN | 0.155 | 0.285 | 0 | 0.3 | | 0.155 | 0.285 | 8 | 1.24 | 2.28 | Pos |
| SP1-SS1- | @1550 | | | | | | | | | | | |
| C1 | | | | | | | | | | | | |
| S1-SG1- | DISP@ | 43.5 | 56.5 | | | | 43.5 | 56.5 | 8 | 348 | 452 | Pos |
| SP1-SS1- | 1560 | | | | | | | | | | | |
| C2 | | | | | | | | | | | | |
| S1-SG1- | DISP@ | 43.5 | 56.5 | | | | 43.5 | 56.5 | 8 | 348 | 452 | Pos |
| SP1-SS1- | 1620 | | | | | | | | | | | |
| C2 | | | | | | | | | | | | |
| S1-SG1- | ATTEN | 0.155 | 0.285 | 0 | 0.3 | | 0.155 | 0.285 | 8 | 1.24 | 2.28 | Pos |
| SP1-SS1- | @1550 | | | | | | | | | | | |
| C2 | | | | | | | | | | | | |
| S1-SG1- | DISP@ | 43.5 | 56.5 | | | 52 | 52 | 52 | 8 | 416 | 416 | Pos |
| SP1-SS1- | 1560 | | | | | | | | | | | |
| C3 | | | | | | | | | | | | |
| S1-SG1- | DISP@ | 43.5 | 56.5 | | | 54 | 54 | 54 | 8 | 432 | 432 | Pos |
| SP1-SS1- | 1620 | | | | | | | | | | | |
| C3 | | | | | | | | | | | | |
| S1-SG1- | ATTEN | 0.155 | 0.285 | 0 | 0.3 | 0.24 | 0.24 | 0.24 | 8 | 1.92 | 1.92 | Pos |
| SP1-SS1- | @1550 | | | | | | | | | | | |
| C3 | | | | | | | | | | | | |
| S1-SG1- | DISP@ | −56.5 | −43.5 | | | | −56.5 | −43.5 | 8 | −452 | −348 | Neg |
| SP1-SS2- | 1560 | | | | | | | | | | | |
| C1 | | | | | | | | | | | | |
| S1-SG1- | DISP@ | −56.5 | −43.5 | | | | −56.5 | −43.5 | 8 | −452 | −348 | Neg |
| SP1-SS2- | 1620 | | | | | | | | | | | |
| C1 | | | | | | | | | | | | |
| S1-SG1- | ATTEN | 0.155 | 0.285 | 0 | 0.3 | | 0.155 | 0.285 | 8 | 1.24 | 2.28 | Neg |
| SP1-SS2- | @1550 | | | | | | | | | | | |
| C1 | | | | | | | | | | | | |
| S1-SG1- | DISP@ | −56.5 | −43.5 | | | | −56.5 | −43.5 | 8 | −452 | −348 | Neg |
| SP1-SS2- | 1560 | | | | | | | | | | | |
| C2 | | | | | | | | | | | | |
| S1-SG1- | DISP@ | −56.5 | −43.5 | | | | −56.5 | −43.5 | 8 | −452 | −348 | Neg |
| SP1-SS2- | 1620 | | | | | | | | | | | |
| C2 | | | | | | | | | | | | |
| S1-SG1- | ATTEN | 0.155 | 0.285 | 0 | 0.3 | | 0.155 | 0.285 | 8 | 1.24 | 2.28 | Neg |
| SP1-SS2- | @1550 | | | | | | | | | | | |
| C2 | | | | | | | | | | | | |
| S1-SG1- | DISP@ | −56.5 | −43.5 | | | | −56.5 | −43.5 | 8 | −452 | −348 | Neg |
| SP1-SS2- | 1560 | | | | | | | | | | | |
| C3 | | | | | | | | | | | | |
| S1-SG1- | DISP@ | −56.5 | −43.5 | | | | −56.5 | −43.5 | 8 | −452 | −348 | Neg |
| SP1-SS2- | 1620 | | | | | | | | | | | |
| C3 | | | | | | | | | | | | |
| S1-SG1- | ATTEN | 0.155 | 0.285 | 0 | 0.3 | | 0.155 | 0.285 | 8 | 1.24 | 2.28 | Neg |
| SP1-SS2- | @1550 | | | | | | | | | | | |
| C3 | | | | | | | | | | | | |
| S1-SG1- | DISP@ | 43.5 | 56.5 | | | | 43.5 | 56.5 | 8 | 348 | 452 | Pos |
| SP2-SS1- | 1560 | | | | | | | | | | | |
| C1 | | | | | | | | | | | | |
| S1-SG1- | DISP@ | 43.5 | 56.5 | | | | 43.5 | 56.5 | 8 | 348 | 452 | Pos |
| SP2-SS1- | 1620 | | | | | | | | | | | |
| C1 | | | | | | | | | | | | |
| S1-SG1- | ATTEN | 0.155 | 0.285 | 0 | 0.3 | | 0.155 | 0.285 | 8 | 1.24 | 2.28 | Pos |
| SP2-SS1- | @1550 | | | | | | | | | | | |
| C1 | | | | | | | | | | | | |
| S1-SG1- | DISP@ | 43.5 | 56.5 | | | | 43.5 | 56.5 | 8 | 348 | 452 | Pos |
| SP2-SS1- | 1560 | | | | | | | | | | | |
| C2 | | | | | | | | | | | | |
| S1-SG1- | DISP@ | 43.5 | 56.5 | | | | 43.5 | 56.5 | 8 | 348 | 452 | Pos |
| SP2-SS1- | 1620 | | | | | | | | | | | |
| C2 | | | | | | | | | | | | |
| S1-SG1- | ATTEN | 0.155 | 0.285 | 0 | 0.3 | | 0.155 | 0.285 | 8 | 1.24 | 2.28 | Pos |
| SP2-SS1- | @1550 | | | | | | | | | | | |
| C2 | | | | | | | | | | | | |
| S1-SG1- | DISP@ | 43.5 | 56.5 | | | | 43.5 | 56.5 | 8 | 348 | 452 | Pos |
| SP2-SS1- | 1560 | | | | | | | | | | | |
| C3 | | | | | | | | | | | | |
| S1-SG1- | DISP@ | 43.5 | 56.5 | | | | 43.5 | 56.5 | 8 | 348 | 452 | Pos |
| SP2-SS1- | 1620 | | | | | | | | | | | |
| C3 | | | | | | | | | | | | |
| S1-SG1- | ATTEN | 0.155 | 0.285 | 0 | 0.3 | | 0.155 | 0.285 | 8 | 1.24 | 2.28 | Pos |
| SP2-SS1- | @1550 | | | | | | | | | | | |
| C3 | | | | | | | | | | | | |
| S1-SG1- | DISP@ | −56.5 | −43.5 | | | | −56.5 | −43.5 | 6 | −339 | −261 | Neg |
| SP2-SS2- | 1560 | | | | | | | | | | | |
| C1 | | | | | | | | | | | | |
| S1-SG1- | DISP@ | −56.5 | −43.5 | | | | −56.5 | −43.5 | 6 | −339 | −261 | Neg |
| SP2-SS2- | 1620 | | | | | | | | | | | |
| C1 | | | | | | | | | | | | |
| S1-SG1- | ATTEN | 0.155 | 0.285 | 0 | 0.3 | | 0.155 | 0.285 | 6 | 0.93 | 1.71 | Neg |
| SP2-SS2- | @1550 | | | | | | | | | | | |
| C1 | | | | | | | | | | | | |
| S1-SG1- | DISP@ | −56.5 | −43.5 | | | | −56.5 | −43.5 | 6 | −339 | −261 | Neg |
| SP2-SS2- | 1560 | | | | | | | | | | | |
| C2 | | | | | | | | | | | | |
| S1-SG1- | DISP@ | −56.5 | −43.5 | | | | −56.5 | −43.5 | 6 | −339 | −261 | Neg |
| SP2-SS2- | 1620 | | | | | | | | | | | |
| C2 | | | | | | | | | | | | |
| S1-SG1- | ATTEN | 0.155 | 0.285 | 0 | 0.3 | | 0.155 | 0.285 | 6 | 0.93 | 1.71 | Neg |
| SP2-SS2- | @1550 | | | | | | | | | | | |
| C2 | | | | | | | | | | | | |
| S1-SG1- | DISP@ | −56.5 | −43.5 | | | | −56.5 | −43.5 | 6 | −339 | −261 | Neg |
| SP2-SS2- | 1560 | | | | | | | | | | | |
| C3 | | | | | | | | | | | | |
| S1-SG1- | DISP@ | −56.5 | −43.5 | | | | −56.5 | −43.5 | 6 | −339 | −261 | Neg |
| SP2-SS2- | 1620 | | | | | | | | | | | |
| C3 | | | | | | | | | | | | |
| S1-SG1- | ATTEN | 0.155 | 0.285 | 0 | 0.3 | | 0.155 | 0.285 | 6 | 0.93 | 1.71 | Neg |
| SP2-SS2- | @1550 | | | | | | | | | | | |
| C3 | | | | | | | | | | | | |
| S1-SG1- | DISP@ | −56.5 | −43.5 | | | | −56.5 | −43.5 | 6 | −339 | −261 | Neg |
| SP2-SS2- | 1560 | | | | | | | | | | | |
| C4 | | | | | | | | | | | | |
| S1-SG1- | DISP@ | −56.5 | −43.5 | | | | −56.5 | −43.5 | 6 | −339 | −261 | Neg |
| SP2-SS2- | 1620 | | | | | | | | | | | |
| C4 | | | | | | | | | | | | |
| S1-SG1- | ATTEN | 0.155 | 0.285 | 0 | 0.3 | | 0.155 | 0.285 | 6 | 0.93 | 1.71 | Neg |
| SP2-SS2- | @1550 | | | | | | | | | | | |
| C4 | | | | | | | | | | | | |

Step 8: Calculate the possible values of all calculation units below the root. Compare to any specs on that unit and use the most restrictive combination. The S1-SG1-SP2 values at the bottom of the following chart, can potentially be the worst cases if nothing is allocated for SP2, since C3 of SP1 is allocated, and taking into account the parameter ranges above for dispersion and attenuation.

### EXAMPLE

| | | | Min | Max | Min Sum of | Max Sum of | | |
|---|---|---|---|---|---|---|---|---|
| Calculation | | Spec | Cumulative | Cumulative | Components | Components | Min | Max |
| Unit ID | Level | Type | Spec | Spec | from Step 7 | from Step 7 | Value | Value |
| S1-SG1- | 5 | DISP@ | | | 348 | 452 | 348 | 452 |
| SP1- | | 1560 | | | | | | |
| SS1-C2 | | | | | | | | |
| S1-SG1- | 5 | DISP@ | | | 348 | 452 | 348 | 452 |
| SP1- | | 1620 | | | | | | |
| SS1-C2 | | | | | | | | |
| S1-SG1- | 5 | DISP@ | | | 416 | 416 | 416 | 416 |
| SP1- | | 1560 | | | | | | |
| SS1-C3 | | | | | | | | |
| S1-SG1- | 5 | DISP@ | | | 432 | 432 | 432 | 432 |
| SP1- | | 1620 | | | | | | |
| SS1-C3 | | | | | | | | |
| S1-SG1- | 4 | DISP@ | | | −1356 | −1044 | −1356 | −1044 |
| SP1-SS2 | | 1560 | | | | | | |
| S1-SG1- | 4 | DISP@ | | | −1356 | −1044 | −1356 | −1044 |
| SP1-SS2 | | 1620 | | | | | | |
| S1-SG1- | 3 | DISP@ | −30 | 30 | −312 | 312 | −30 | 30 |
| SP2 | | 1560 | | | | | | |
| S1-SG1- | 3 | DISP@ | −30 | 30 | −312 | 312 | −30 | 30 |
| SP2 | | 1620 | | | | | | |

Step 9: Calculate the allowed range for the target within each spec unit that has a cumulative spec. Use the most restrictive combination of these results and any specs at the target level. The target is the cable piece S1-SG1-SP1-SS1-C1. Dispersion is cumulative across span group, but in this example the attenuation is not as it will be corrected by amplifiers or repeaters/wave regenerators and a simple maximum attenuation specification was utilized. The below chart shows the worst case values that could be selected for S1-SG1-SP1-C1, given the SG1 specification and SP1 specification using the procedures leading to equation 4. The dispersion at the different wavelengths is compared, The dispersion at 1560 nm for the target section (S1-SG!-SP1-C1) must be between 18.25 ps/nm·km and 77.75 ps/nm·km and the dispersion at 1620 nm must be between 16.25 ps/nm·km and 75.75 ps/nm·km.

### EXAMPLE

| | | Min | |
|---|---|---|---|
| | Spec | of | Max of |
| Spec unit | type | range | range |
| S1-SG1 | DISP@ | 15.75 | 80.25 |
| | 1560 | | |
| S1-SG1 | DISP@ | 13.75 | 78.25 |
| | 1620 | | |
| S1-SG1-SP1 | DISP@ | 18.25 | 77.75 |
| | 1560 | | |
| S1-SG1-SP1 | DISP@ | 16.25 | 75.75 |
| | 1620 | | |

For the simple 3 parameter system requirement a selected fiber must meet the following requirements:

| | Min | Max |
|---|---|---|
| | of | of |
| Spec type | range | range |
| DISP@1560 | 18.25 | 77.75 |
| DISP@1620 | 16.25 | 75.75 |
| ATTEN@1550 | 0 | 0.3 |

In the exemplary system and fiber distribution there is a dependant relationship for the dispersion at 1560 nm and at 1620 nm. A statistical analysis could potentially provide the mapping function as described in Equations 7 and 11 with the following parameters:

Fiber type

| | M₁₂ | B₁₂ | S_{d12} | r₁₂ |
|---|---|---|---|---|
| Positive | 0.99 | 0 | 0.1 | 1.3 |
| Negative | 1.01 | 0 | 0.5 | 1.3 |

Step 10:

Taking the piece length of 8 km, the fiber inventory is searched manually or electronically, and a suitable fiber that meets both the source wavelength requirements @1560 and @1620 is found with the following characteristics:

### EXAMPLE

| | Per/km | per fiber |
|---|---|---|
| DISP@1560 | 40 | 320 |
| DISP@1620 | 47 | 376 |
| ATTEN@1550 | 0.2 | 1.6 |

Step 11:

Determine the allowable range for unallocated fiber that will keep each spec unit within its specs for 1560 nm dispersion.

Calculate these base ranges, example:

| | | | | | Min | Max | | | |
|---|---|---|---|---|---|---|---|---|---|
| | | Min | Max | Total | unallocated | unallocated | Total | Min | Max |
| Spec Unit | | spec | spec | allocated | @1560 | @1560 | allocated | spec | spec |
| ID | Level | @1560 | @1560 | @1560 | Uₘᵢₙ₁ | Uₘₐₓ₁ | @1620 | @1620 | @1620 |
| S1 | 1 | None | None | | | | | | |
| S1-SG1 | 2 | −20 | 20 | 416 | −756 | −716 | 432 | −20 | 20 |
| S1-SG1-SP1 | 3 | −30 | 30 | 416 | −766 | −706 | 432 | −30 | 30 |
| S1-SG1-SP1- | 4 | None | None | | | | | | |
| SS1 | | | | | | | | | |

Steps 12-15:

Convert each base range into the corresponding values for each essentially linearly dependent parameter using equations 11 and 12 excluding the first parameter. Then for each dependant parameter (excluding the first) take the most restrictive overlap of the converted ranges, and use the most restrictive range for each dependant parameter (excluding the first) to calculate the range for the target fiber. Compare the new upper and lower acceptable values for each dependant parameter with those from step 9 and determine the most restrictive new range for acceptable parametric values The most restrictive spec overlap for the source wavelength @1620 nm is 28.486 ps/nm-km to 47.59 ps/nm-km, the selected-fiber meets the spec value so it is acceptable for use in cable piece C1.

If the fiber had not met the spec value, the next fiber in inventory that had characteristics within the independently calculated value ranges for step 9 would be selected and the calculations of steps 10 through 15 would be redone until a fiber meeting the requirements is found.

Example for Setting New Restrictions on 1620 nm Dispersion:

Convert base ranges @1560 nm to values @1620 nm. Calculate limits on 1620 nm dispersion based on 1560 nm dispersion using equations 11 and 12:

| | Calculation | Calculation |
|---|---|---|
| | for S1-SG1 | for S1-SG1-SP1 |
| Σ l ^{P}ᵤ | 40 | 16 |
| Σ l ^{N}ᵤ | 48 | 24 |
| d^{P}ₘₑₐₙ₁ | 50 | 50 |
| d^{N}ₘₑₐₙ₁ | −50 | −50 |
| s^{P}_{d1} | 5 | 5 |
| s^{N}_{d1} | 5 | 5 |
| xₘᵢₙzₐ | −0.809 | −1.83 |
| xₘₐₓz_{A} | −0.718 | −1.53 |
| d^{P}ₘₑₐₙ₂ | 50 | 50 |
| d^{N}ₘₑₐₙ₂ | −50 | −50 |
| U^{new}ₘᵢₙ₂ | −792.724 | −784.412 |
| U^{new}ₘₐₓ₂ | −679.887 | −688.932 |
| d^{new}ₚₘᵢₙ₂ | 28.485 | 28.366 |
| d^{new}ₚₘₐₓ₂ | 47.59 | 47.8 |

These steps culminate in the notion that by selecting fibers that meet multiple specification groupings, but using manageable local specification criteria, the broadest range of fibers in or near inventory can be used, advantageously managing inventory costs and making manufacturing more efficient. As discussed above, the present inventions provide a proactive monitoring of at least one, but preferably multiple, optical performance parameters in an optical component selection process.

The foregoing examples are made by way of illustration and setting forth a full explanation of the instant inventions. Other embodiments are possible. For example, systems for which the most benefit would be provided would be several thousand kilometers long, potentially with side taps, cross connects, drop/adds etc. Systems according to the present inventions could contain linearly length dependant parameters such as dispersion and attenuation, mutually dependant parameters such as dispersion at different wavelengths or attenuation at different wavelengths and or non-linearly length dependant parameters, such as PMD. It is contemplated that there can be adjustments to either minimize or maximize non-linear effects as required.

Practice of the present inventions provides cables and/or systems dynamically manufactured with respect to changing optical parameters relating to optical fiber inventories and/or desired optical transmissions design or field goals. Moreover, the optical fiber being selected need not actually be in stock, as a virtual inventory can provide the necessary data, for example, a virtual inventory comprising to-be-manufactured or delivered optical fibers.

The present inventions can be extended to any parameter that is related to the length. Calculation of possible values of unallocated fibers according to the present inventions will now be described for non-linearly dependant parameters, for example, polarization mode dispersion (PMD). Certain parameters, PMD specifically, are not linearly related to length.

The equations for calculating acceptable fiber ranges are:

The PMD coefficient P_{c} for a fiber is in units of picoseconds per root (kilometer).

ps/\sqrt{km} (24)

The absolute PMD value for a fiber is:

P_{A=P}_{C}\sqrt{l} (25)

where l is the length of the fiber.

The total absolute PMD for a group of serially connected fibers is:

$${P}_{AT} = \sqrt{\sum {( {P}_{A} )}^{2} =} \sqrt{\sum ( {P}_{c}^{2} l )} . \qquad ( 26 )$$

So, the PMD coefficient for the group is

$${P}_{cT} = \frac{{P}_{AT}}{\sqrt{\sum l}} = \sqrt{\frac{\sum ( {P}_{c}^{2} l )}{\sum l}} . \qquad ( 27 )$$

Working with the squares of the coefficients, the system can be treated as if it was linearly length dependent:

$${P}_{AT}^{2} = \sum ( {P}_{c}^{2} l ) . \qquad ( 28 )$$

The fiber being selected, the unselected fibers, and the already selected fibers are:

$${P}_{AT}^{2} = {P}_{cp}^{2} {l}_{p} + \sum ( {P}_{cu}^{2} {l}_{u} ) + \sum ( {P}_{cA}^{2} {l}_{A} ) . \qquad ( 29 )$$

P_{cT} is considered the target and V_{cT} the variation allowed around the target, and if expressed in picoseconds per root (kilometer) then:

$${P}_{cp}^{2} {l}_{p} + \sum ( {P}_{cu}^{2} {l}_{u} ) + \sum ( {P}_{cA}^{2} {l}_{A} ) \leq {( {P}_{cT} + {V}_{cT} )}^{2} \sum l \\ and \\ {P}_{cp}^{2} {l}_{p} + \sum ( {P}_{cu}^{2} {l}_{u} ) + \sum ( {P}_{cA}^{2} {l}_{A} ) \geq {( {P}_{cT} - {V}_{cT} )}^{2} \sum l . \qquad ( 30 )$$

This is the same form as the equations [1] for the linearly length dependent parameters, so the same techniques are used for PMD by dealing with the squares of the PMDs.

Because system performance parameters are constantly integrated in the fiber selection process according to the present inventions, practice of the present inventions significantly reduces or altogether eliminates the risk of manufactured cable sections being non-compliant with respect to system performance specifications. The system parameters may change during a cable build-out, and these data can be factored in to the selection process of the present inventions. In addition, practice of the present inventions can reduce or eliminate the expenses associated with, or need for, optical compensation or adjusting in the field.

The present invention has thus been described with reference to the foregoing embodiments, the embodiments are intended to be illustrative of the inventive concepts disclosed herein rather than limiting. Persons of skill in the art will appreciate that variations and modifications of the foregoing embodiments may be made without departing from the scope of the appended claims. The fiber optic cable can include ripcords, tapes, water-blocking components, armor, anti-buckling members, buffer tube filling compounds, core binders, and/or other cable components. As an illustration without limitation, the components and cable constructions disclosed in the following United States Patent Nos., respectively incorporated by reference herein, can be considered as possibly being used in conjunction with or complementary with the present inventions: U.S. Pat. Nos. 5,621,841; 5,930,431; 5,970,196; 6,014,487; 6,018,605; 6,064,789; 6,188,821; and 6,192,178.

Accordingly, what is claimed is:

1. A method of manufacturing an optical path for signal transmission, said optical path having at least one linearly length dependent, optical parameter requirement associated therewith, comprising:
(a) providing at least three optical fibers in optical communication along said optical transmission path, said optical fibers defining first, second and third optical fibers in said transmission path, said first, second and third optical fibers having respective, predetermined optical characteristics complementary to that of said essentially linearly length dependant optical parameter, said first, second and third optical fibers to be selected from a real or virtual set of optical fibers with a distribution of said linear dependant optical parameter that would likely not meet the concatenated path requirements if said optical fibers were selected randomly;
(b) selecting said first optical fiber being selected using a reasonable parametric distribution requirement and defining a first allocated optical fiber; and
(c) selecting said second optical fiber for inclusion in said optical path using the same criteria as the first optical fiber; said predetermined optical parameter of said second optical fiber is then compared to a maximum and minimum local selection criteria established with reference to the optical characteristics of said first allocated optical fiber and with reference to a parametric value for the third optical fiber so that the optical characteristics of said second optical fiber are within an optical performance range, said optical performance range for the second optical fiber being defined as:
$${d}_{p min} = ( T - {V}_{L} - \sum {d}_{A} {l}_{A} - \sum {d}_{u max} {l}_{u} ) / {l}_{p}$$
$${d}_{p max} = ( T + {V}_{U} - \sum {d}_{A} {l}_{A} - \sum {d}_{u min} {l}_{u} ) / {l}_{p}$$
where,
d_{p min}=a minimum length dependent value of said range;
d_{p max}=a maximum length dependent value of said range;
T=an end to end path target value;
V_{U}=an allowed upper variance around said end to end path target value;
V_{L}=an allowed lower variance around said end to end path target value;
d_{A}=a normalized value of said first (allocated) optical fiber in said optical path;
dᵤₘₐₓ=a normalized value for a reasonable maximum value for the third (unallocated) optical fiber in said optical path;
dᵤₘₘᵢₙ=a normalized value for a reasonable minimum value for the third (unallocated) optical fiber in said optical path;
l_{A}=a length of said first (allocated) optical fiber already selected for said optical path; and
lₚ=the length of said second optical fiber being selected;
lᵤ=the length of said third (unallocated) optical fiber to be selected for said optical path.

2. The method claim 1, wherein if said optical parameter value for said second optical fiber does not meet the local restrictionsit is put back into inventory and a new second optical fiber is selected, the selection criteria calculations are redone until an acceptable second optical fiber is selected, and said acceptable second fiber is then allocated.

3. The method of claim 2, said set of selection criteria calculations being performed for each linearly dependant optical parameter in the selection set for each optical fiber whereby a series of optical fibers are accepted and allocated.

4. The method of claim 1, at least two of the parameters having a dependant relationship with respect to each other, the local selection criteria for said second fiber being a further restriction for each dependant parameter from the dependant relationship, and wherein:
$${d}_{p min 2}^{new} = ( {T}_{2} - {V}_{2} - {U}_{max 2}^{new} - \sum {d}_{A2} {l}_{A} ) / {l}_{p}$$
$${d}_{p max 2}^{new} = ( {T}_{2} + {V}_{2} - {U}_{min 2}^{new} - \sum {d}_{A2} {l}_{A} ) / {l}_{p}$$
where,
d^{new}_{p min2}=a minimum length dependent value of said range;
d^{new}_{p max2}=a maximum length dependent value of said range;
T₂=an end to end path target value
V₂=an allowed variance around said end to end path target value;
d_{A2}=a normalized value of said first (allocated) optical fiber in said optical path;
l_{A}=a length of said first (allocated) optical fiber already selected for said optical path; and
lₚ=the length of said second optical fiber being selected;
U^{new}ₘₐₓ₂=a highest value for the remainder of one of said linearly dependent parameters expected because of the linear relationship of the parameters;
U^{new}ₘᵢₙ₂=a lowest value for the remainder of one of said linear dependent parameters expected because of the linear relationship of the parameters.

5. The method of claim 1, said optical path including one or more nested sub-paths, each one with targets and possible variances said second fiber must meet, the variances being the most restrictive of all overlaid path or sub-path requirements.

6. A method of manufacturing an optical path for signal transmission, said optical path having at least one non-linearly length dependent, length-mappable, optical parameter requirement associated therewith, comprising:
(a) at least three optical fibers in optical communication along said optical transmission path, said optical fibers defining first, second and third optical fibers in said transmission path, said first, second and third optical fibers having respective, predetermined optical characteristics complementary to that of said length-mappable dependant optical parameter, said first, second and third optical fibers being selected from a real or virtual set of optical fibers with a distribution of said length-mappable dependant optical parameter that would likely not meet the concatenated path requirements if said optical fibers were selected randomly;
(b) said first optical fiber being selected using a reasonable parametric distribution requirement and defining a first allocated optical fiber; and
(c) said second optical fiber being selected for inclusion in said optical path using the same fiber selection criteria as the first optical fiber; said optical parameter of said second optical fiber being compared to a maximum and minimum local selection criteria established with reference to the optical characteristics of said first allocated optical fiber and with reference to the parametric value for optical fiber three so that the optical characteristics of said second optical fiber are within an optical performance range, said optical performance range for the second fiber being defined as:
d_{p min}(lₚ)=pₘᵢₙ [T,V_{L},dₐ(lₐ), d_{u max} (lᵤ)]
d_{p max}(lₚ)=pₘₐₓ[T,V_{U},dₐ(lₐ),d_{u min}(lᵤ)]
where,
d_{p min} (lₚ)=a minimum value for the parameter at length lₚ;
d_{p max} (lₚ)=a maximum value for the parameter at length lₚ;
T=an end to end path target value
V_{U}=an allowed upper variance around said end to end path target value;
V_{L}=an allowed lower variance around said end to end path target value;
d_{A} (lₐ)=the value of parameter P for the optical fibers already allocated;
dᵤₘₐₓ (lᵤ)=a value for a reasonable maximum value for the unallocated optical fiber in said optical path;
dᵤₘᵢₙ (lₐ)=a value for a reasonable minimum value for the unallocated optical fiber in said optical path;
l_{A}=a length of said first (allocated) optical fiber already selected for said optical path;
lₚ=the length of said second optical fiber being selected;
lᵤ=the length of said third (unallocated) optical fiber to be selected for said optical path; and
pₘᵢₙ[T,V_{L}, dₐ(lₐ),d_{u max}(lᵤ)]&pₘₐₓ[T,V_{U},dₐ(lₐ), d_{u min}(lᵤ)]=the appropriate equation to determine the allowable range based on the length-mapping and other parameters.

7. The method of claim 6, if said optical parameter value for said second optical fiber does not meet the local restrictions, the fiber is de-selected and a new second optical fiber is selected, the selection criteria calculations are redone until an acceptable second optical fiber is selected, said acceptable second optical fiber is classified as allocated and the said third optical fiber and subsequent optical fibers are selected using selection criteria calculations.

8. The method of claim 7 wherein the selection criteria calculations are performed for each non-linearly length dependant optical parameter in the selection set for each optical fiber.

9. The method of claim 8, wherein the paths or sub-paths have one or more non-linear, length dependant parameters.

10. An optical path for signal transmission, said optical path having at least two length dependent, essentially linearly related optical parameters associated therewith, comprising:
(a) at least two optical fibers in optical communication along said optical transmission path, said optical fibers defining first and second optical fibers in said transmission path, said is first and second optical fibers having respective, predetermined optical characteristics complementary to that of said essentially linearly related optical parameters; and
(b) said second optical fiber being selected for inclusion in said optical path with reference to the optical characteristics of said first (allocated) optical fiber so that the optical characteristics of said second optical fiber are within an optical performance range, said optical performance range being defined as:
$${d}_{p min} = ( T - {V}_{L} - {U}_{max} - \sum {d}_{A} {l}_{A} ) / {l}_{p}$$
$${d}_{p max} = ( T + {V}_{U} - {U}_{min} - \sum {d}_{A} {l}_{A} ) / {l}_{p}$$
where,
d_{p min}=a minimum length dependent value of said range;
d_{p max}=a maximum length dependent value of said range;
T=a target value for said second optical fiber in said range;
V_{U}=an allowed upper variance around said target value;
V_{L}=an allowed lower variance around said target value;
Uₘₐₓ=a highest value for the remainder of one of said linearly dependent parameters expected because of the linear relationship of the parameters;
Uₘᵢₙ=a lowest value for the remainder of one of said linear dependent parameters expected because of the linear relationship of the parameters;
d_{A}=a normalized value of said first (allocated) optical fiber in said optical path;
l_{A}=a length of said first (allocated) optical fiber already selected for said optical path; and
lₚ=the length of said second optical fiber.

11. An optical transmission system, comprising:
at least two length dependent, essentially linearly related optical parameters;
optical fibers to be in optical communication along the optical transmission path defining first and second optical fibers in the transmission path having predetermined optical characteristics complementary to that of the essentially linearly related optical parameters;
the second optical fiber being selected for inclusion in the optical path with reference to the optical characteristics of the first optical fiber, said selection being made so that the optical characteristics of the second optical fiber are within a predetermined optical performance range.

12. A method for selecting an optical fiber for use in an optical path, said method comprising:
(a) determining at least two length dependent, essentially linearly related optical parameters associated with said optical path;
(b) identifying at least two optical fibers to be in optical communication along said optical transmission path, thereby defining first and second optical fibers;
(c) determining optical characteristics respectively of said first and second optical fibers that are complementary to that of said essentially linearly related optical parameters; and
(d) selecting said second optical fiber, for inclusion in said optical path, with reference to the optical characteristics of said first optical fiber so that the optical characteristics of said second optical fiber are within a predetermined optical performance range.

13. The method of claim 1, said optical performance range being defined as:
$${d}_{p min} = ( T - {V}_{L} - {U}_{max} - \sum {d}_{A} {l}_{A} ) / {l}_{p}$$
$${d}_{p max} = ( T + {V}_{U} - {U}_{min} - \sum {d}_{A} {l}_{A} ) / {l}_{p}$$
where,
d_{p min}=a minimum length dependent value of said range;
d_{p max}=a maximum length dependent value of said range;
T=a target value for said second optical fiber in said range;
Vᵤ=an allowed upper variance around said target value;
V_{L}=an allowed lower variance around said target value;
Uₘₐₓ=a highest value for the remainder of one of said linearly dependent parameters expected because of the linear relationship of the parameters;
Uₘᵢₙ=a lowest value for the remainder of one of said linear dependent parameters expected because of the linear relationship of the parameters;
d_{A}=a normalized value of said first (allocated) optical fiber in said optical path;
l_{A}=a length of said first (allocated) optical fiber already selected for said optical path; and
lₚ=the length of said second optical fiber.
